(19) United States
(12) Patent Application Publication
(10) Pub. No.: US 2006/0078772 A1
(43) Pub. Date: Apr. 13, 2006

(54) Power supply apparatus with fuel cell assembly

(75) Inventors: Chen-Yu Yu, Taoyuan Hsien (TW); Hsi-An Liu, Taoyuan Hsien (TW); Sheng-Yan Hu, Taoyuan Hsien (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Delta Electronics, Inc.

(21) Appl. No.: 11/025,286

(22) Filed: Dec. 29, 2004

(30) Foreign Application Priority Data
Oct. 13, 2004 (TW) 093131055

(51) Int. Cl. H01M 8/04

(52) U.S. Cl. 429/23; 429/34

(57) ABSTRACT

A power supply apparatus includes a fuel cell assembly, a feeding device, a blower, a detecting circuit and a converting circuit. The fuel cell assembly performs an electrochemical reaction to generate an input voltage. The feeding device has therein a fluid fuel and in fluid connection with the fuel cell assembly so as to introduce the fluid fuel into the fuel cell assembly. The blower is used for introducing ambient air into the fuel cell assembly. The detecting circuit is electrically connected to the load, detects an operating voltage of the load, and generates a triggering signal in response to the detecting result. The converting circuit is electrically connected between the fuel cell assembly and the detecting circuit, converts the input voltage into the operating voltage in response to the triggering signal, and offers the operating voltage to the load.

### FIELD OF THE INVENTION

The present invention relates to a power supply apparatus, and more particularly to a power supply apparatus using fuel cells to provide electricity.

### BACKGROUND OF THE INVENTION

Fuel cells are well known and commonly used to produce electrical energy by means of electrochemical reactions. Compared to conventional power generation apparatus, fuel cells have advantages of less pollutant, lower noise generated, increased energy density and higher energy conversion efficiency. Fuel cells can be used in portable electronic products, home-use or plant-use power generation systems, transportation, military equipment, space industry, large-size power generation systems, etc.

According to the electrolytes, fuel cells are typically classified into several types, e.g. an alkaline fuel cell (AFC), a phosphoric acid fuel cell (PAFC), a molten carbonate fuel cell (MCFC), a solid oxide fuel cell (SOFC) and a proton exchange membrane fuel cell (PEMFC). Depending on types of the fuel cells, the operation principles are somewhat different. For example, in the case of a direct methanol fuel cell (DMFC) which has the same structure as the PEMFC but uses liquid methanol instead of hydrogen as a fuel source, methanol is supplied to the anode, an oxidation reaction occurs in the presence of a catalyst, and protons, electrons and carbon dioxide are generated. The protons reach the cathode through the proton exchange membrane. Meanwhile, in the cathode, oxygen molecules take electrons from the anode and are reduced to oxygen ions by reduction. The oxygen ions react with hydrogen ions from the anode and thus produce water.

As known, an individual fuel cell unit supplies limited voltage (approximately 0.4 V). For a purpose of offering a sufficient operating voltage to an electronic product, a plurality of fuel cell units are connected in series so as to form a fuel cell assembly. Depending on the arrangement of the fuel cell units, the fuel cell assemblies can be divided into two types, i.e. a stacked fuel cell assembly and a planar fuel cell assembly.

Referring to FIG. 1, an exploded view of a conventional stacked fuel cell assembly is illustrated. The stacked fuel cell assembly 10 comprises at least two membrane-electrolyte assemblies (MEAs) 11, a bipolar plate 12 located between two adjacent MEAs 11 and two electrode plates 13 and 14 at opposite ends of the fuel cell assembly. Each MEA 11 includes an anode 111, a proton exchange membrane 112 and a cathode 113. The bipolar plate 12 comprises a plurality of channels 121 for flowing fuels and oxygen molecules therethrough. However, since the stacked fuel cell assembly 10 requires a large amount of cell units to be assembled in a stacked form, the thickness and the weight thereof are considerably high. Therefore, the usage of a stacked fuel cell assembly is restricted in some situations.

Referring to FIG. 2, an exploded view of a conventional planar fuel cell assembly is illustrated. The planar fuel cell assembly 20 comprises a metal frame 21, a plurality of membrane-electrolyte assemblies (MEAs) 22 and two electrode plates 23 and 24 at opposite ends of the fuel cell assembly. Likewise, each MEA 22 includes an anode, a proton exchange membrane and a cathode (not shown), and is embedded in the corresponding opening 211 of the frame 21. Furthermore, two current collectors 212 are disposed at one side of the frame 21 as the current output terminals of the planar fuel cell assembly 20. Each of the electrode plates 23 and 24 comprises channels 231 for flowing fuels and oxygen molecules therethrough. Since such planar fuel cell assembly 20 is advantageous of being easily assembled and having less weight, thickness and volume, it is widely used in portable electronic products.

On the other hand, when a portable electronic product is to be charged, the charger (not shown) should be first plugged into a socket. Via the socket, commercial AC power is transmitted to the AC/DC converter of the charger to be converted into DC power. The DC power is then transmitted to the portable electronic product to be charged. This conventional charger can quickly charge the portable electronic product only when the commercial AC power is obtainable. Therefore, the utility of the portable electronic product is limited.

### SUMMARY OF THE INVENTION

The present invention provides a power supply apparatus incorporating with a planar fuel cell assembly so as to be used when no commercial AC power is obtainable.

The present invention provides a power supply apparatus incorporating with a planar fuel cell assembly so as to offer sufficient operating voltages for at least one load.

In accordance with a first aspect of the present invention, there is provided a power supply apparatus for offering a voltage to be used with a load. The power supply apparatus comprises a fuel cell assembly, a feeding device, a blower, a detecting circuit and a converting circuit. The fuel cell assembly performs an electrochemical reaction to generate an input voltage. The feeding device has therein a fluid fuel and in fluid connection with the fuel cell assembly so as to introduce the fluid fuel into the fuel cell assembly. The blower is used for introducing ambient air into the fuel cell assembly. The detecting circuit is electrically connected to the load, detects an operating voltage of the load, and generates a triggering signal in response to the detecting result. The converting circuit is electrically connected between the fuel cell assembly and the detecting circuit, converts the input voltage into the operating voltage in response to the triggering signal, and offers the operating voltage to the load.

In an embodiment, the load is a portable electronic product.

In an embodiment, the fluid fuel comprises methanol or hydrogen.

In an embodiment, the feeding device is detachable from the power supply apparatus to supplement the fluid fuel.

In an embodiment, the converting circuit is a charge pumping circuit, and especially a DC/DC converter.

In an embodiment, the power supply apparatus further comprises a waste liquid container for storing waste liquid generated from the electrochemical reaction and the unreacted fluid fuel.

In an embodiment, the fuel cell assembly is a planar fuel cell assembly.

In an embodiment, the detecting circuit and the converting circuit are mounted on a circuit board.

In accordance with a second aspect of the present invention, there is provided a power supply apparatus for offering a plurality of output voltages. The power supply apparatus comprises a fuel cell assembly, a feeding device, a blower and a converting circuit. The fuel cell assembly performs an electrochemical reaction to generate an input voltage. The feeding device has therein a fluid fuel and in fluid connection with the fuel cell assembly so as to introduce the fluid fuel into the fuel cell assembly. The blower is used for introducing ambient air into the fuel cell assembly. The converting circuit is electrically connected to the fuel cell assembly for converting the input voltage into the plurality of output voltages to be used with corresponding loads.

In accordance with a third aspect of the present invention, there is provided a power supply apparatus for offering a plurality of output voltages. The power supply apparatus comprises a fuel cell assembly, a feeding device, a waste liquid container, a mixing container, a blower, and a converting circuit. The fuel cell assembly performs an electrochemical reaction to generate an input voltage. The feeding device has therein a fluid fuel. The waste liquid container is used for storing waste liquid generated from the electrochemical reaction and the unreacted fluid fuel. The mixing container is connected between the feeding device, the planar fuel cell assembly and the waste liquid container, and mixes the fluid fuel from the feeding device and the waste liquid from the waste liquid container to introduce a mixture of the fluid fuel and the waste liquid into the fuel cell assembly. The blower is used for introducing ambient air into the fuel cell assembly. The converting circuit is electrically connected to the fuel cell assembly for converting the input voltage into the plurality of output voltages to be used with corresponding loads.

In an embodiment, the power supply apparatus further comprises a return pipe connected between the mixing container and the waste liquid container for recycling the waste liquid to the mixing container therethrough.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is an exploded view of a stacked fuel cell assembly according to prior art;

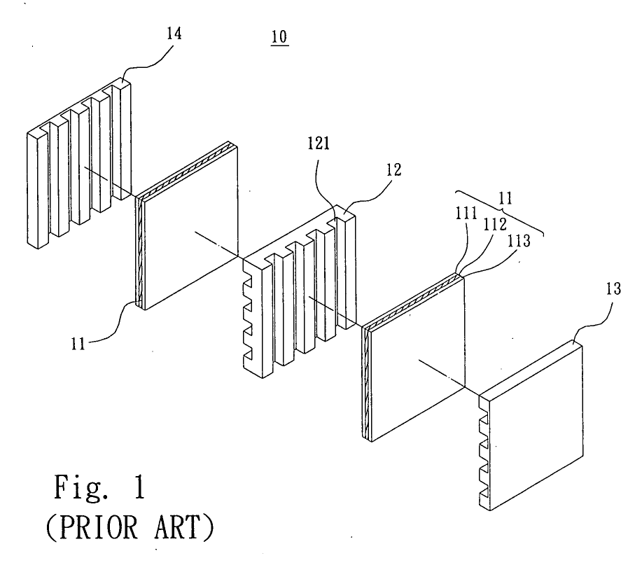

FIG. 2 is an exploded view of a planar fuel cell assembly according to prior art;

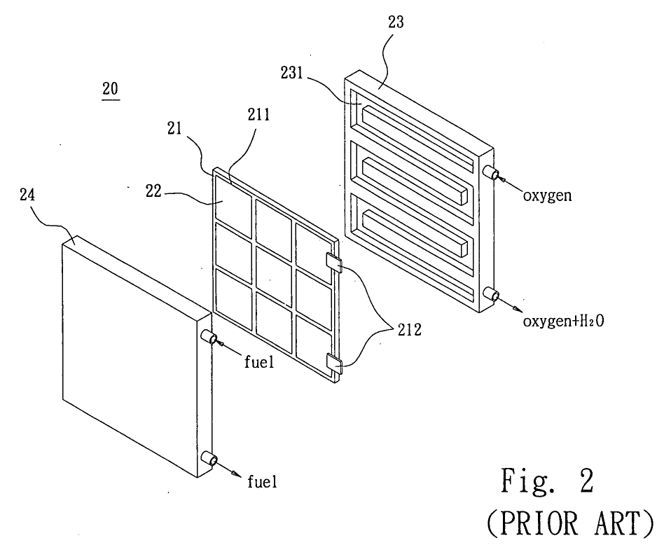

FIG. 3(a) is a schematic view illustrating a power supply apparatus according to a preferred embodiment of the present invention;

FIG. 3(b) is a functional block diagram illustrating the power supply apparatus of FIG. 3(a);

FIG. 4(a) is an exploded view illustrating a power supply apparatus according to another preferred embodiment of the present invention;

FIG. 4(b) is a schematic view illustrating the power supply apparatus of FIG. 4(a);

FIG. 5 is an exploded view of an illustrative planar fuel cell assembly;

FIG. 6(a) is a schematic view illustrating a power supply apparatus according to another preferred embodiment of the present invention; and

FIG. 6(b) is a functional block diagram illustrating the power supply apparatus of FIG. 6(a).

### DETAILED DESCRIPTION OF THE PREFERRED EMBODIMENT

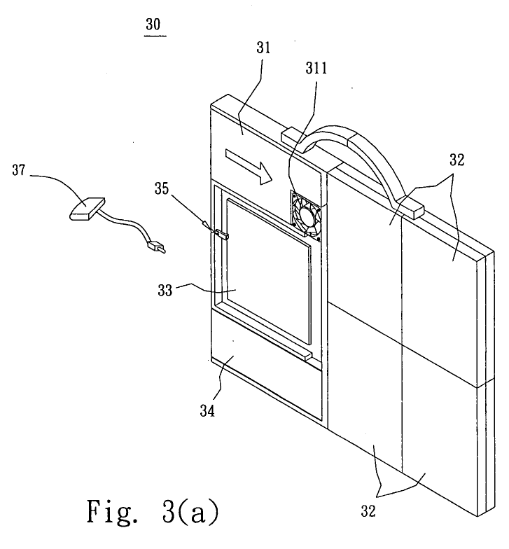

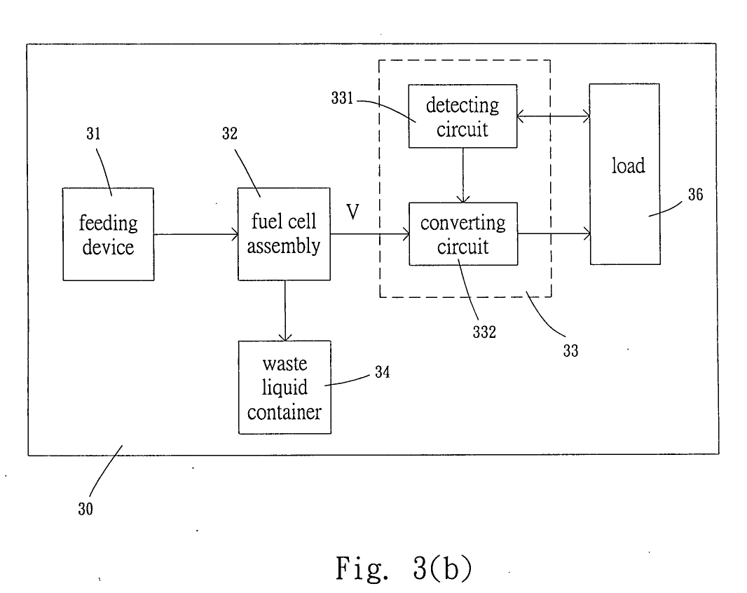

Referring to FIGS. 3(a) and 3(b), a power supply apparatus according to a preferred embodiment of the present invention is shown. Via an output terminal 35, this power supply apparatus 30 can offer an operating voltage to a load 36 such as a portable electronic product, for example a notebook, a personal digital assist, a digital still camera or a mobile phone.

The structure of the power supply apparatus 30 shown in FIG. 3(a) comprises a feeding device 31, a blower 311, a planar fuel cell assembly 32, a circuit board 33 and optionally a waste liquid container 34. The feeding device 31 contains fluid fuel, for example methanol, hydrogen or the like, to be used with the planar fuel cell assembly 32. The feeding device 31 is removably disposed within the power supply apparatus 30 and in fluid connection with the planar fuel cell assembly 32. For example, the feeding device 31 can be detached to supplement the fluid fuel. The blower 311 is disposed adjacent to the planar fuel cell assembly 32. The outlet of the blower 311 is connected to the air inlet of the planar fuel cell assembly 32 so as to introduce the ambient air into the planar fuel cell assembly 32. The ambient air offers the essential component, i.e. oxygen, for performing the oxidation reaction in the planar fuel cell assembly 32. The product generated from the electrochemical reaction (i.e. water) and the unreacted fluid fuel are stored in the waste liquid container 34.

Referring to FIG. 3(b), a converting circuit 331 and a detecting circuit 332 are arranged on the circuit board 33. In a case that the power supply apparatus 30 is in electrical connection with the load 36, the detecting circuit 332 will detect the operating voltage required for the load 36 and generates a triggering signal according to the detecting result. In some embodiment, the converting circuit 331 is a charge pumping circuit such as a DC/DC converter. The DC/DC converter 331 is electrically connected to the planar fuel cell assembly 32, the detecting circuit 332 and the load 36 in series. A DC input voltage (V) from the planar fuel cell assembly 32 is received by the DC/DC converter 331. In response to the triggering signal from the detecting circuit 332, the DC input voltage is converted into the operating voltage required for the load 36 and then transmitted to the load 36 via the output terminal 35. Accordingly, the power supply apparatus 30 can offer a sufficient operating voltage to the load 36 or use as a charger for charging the load 36 in a case that no commercial AC power supply is obtainable.

Furthermore, for complying with the specification of the input terminal of the load 36, a power adapting device 37 is provided to connect the output terminal 35 of the power supply apparatus 30 with the input terminal of the load 36 so as to offer required power to the load 36. In order to enhance user's convenience, the power adapting device 37 may be designed to have a plurality of output terminals for connecting with several loads.

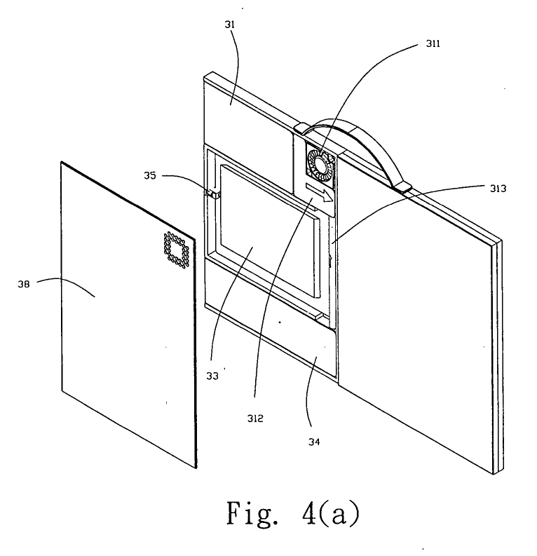

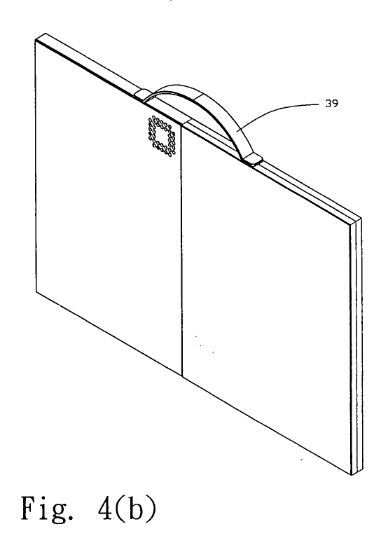

A further embodiment of a power supply apparatus is illustrated in FIGS. 4(a) and 4(b). In this embodiment, the arrangement of the feeding device 31, the planar fuel cell assembly 32, the circuit board 33 and the waste liquid container 34 included therein are similar to those shown in FIG. 3(a), and are not to be redundantly described herein. However, a mixing container 312 is further provided between the feeding device 31 and the planar fuel cell assembly 32, and a return pipe 313 is connected between the mixing container 312 and the waste liquid container 34. The water generated from the electrochemical reaction in the planar fuel cell assembly 32 and the unreacted fluid fuel flow into the waste liquid container 34, and can be recycled to the mixing container 312 via the return pipe 313. In this embodiment, the fluid fuel contained in the feeding device 31 can be pure methanol or high-purity hydrogen. Optionally, a control valve can be provided between the feeding device 31 and the mixing container 312 for controlling the flow rate of the fluid fuel and adjusting the concentration of the fluid fuel in the mixing container 312 to an acceptable level. Another control valve can also be provided between the waste liquid container 34 and the mixing container 312. Alternatively, a cover plate 38 is provided to protect the components of the power supply apparatus. For a purpose of conveniently carrying the overall product, a handle 39 can be optionally provided at the top edge thereof.

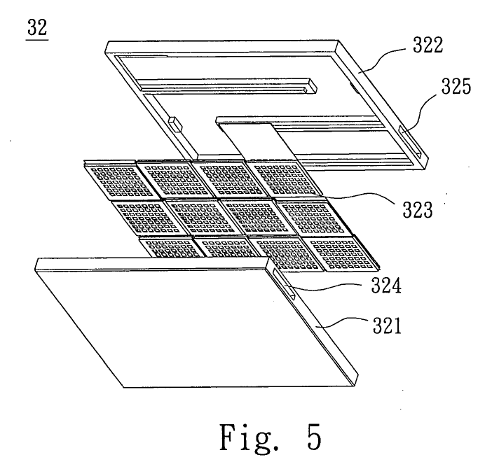

An example of the planar fuel cell assembly 32 is illustrated in FIG. 5. The planar fuel cell assembly 32 comprises a first channel-forming plate 321, a second channel-forming plate 322 and a group of fuel cell units 323 connected in series. The first channel-forming plate 321 has a fuel inlet 324 to be coupled with the fuel outlet of the feeding device 31 so as to introduce the fluid fuel into the planar fuel cell assembly 32 via the fuel inlet 324. The second channel-forming plate 322 has an air inlet 325 to be coupled with the air outlet of the blower 311 so as to introduce the ambient air into the planar fuel cell assembly 32 via the air inlet 325. As known, each fuel cell unit 323 comprises a meshed metal plate and a membrane-electrolyte assembly (MEA). Take a direct methanol fuel cell (DMFC) for example. During operation of such planar fuel cell assembly 32, the methanol solution is supplied into the channel defined by the channel-forming plate 321 via the fuel inlet 324. In the anode of the membrane-electrolyte assembly, an oxidation reaction occurs in the presence of a catalyst, and thus protons, electrons and carbon dioxide are generated. The protons reach the cathode through the proton exchange membrane to the cathode. The oxygen molecules containing in the air will flow through the meshed metal plate of the individual fuel cell unit to the cathode. Meanwhile, in the cathode, oxygen molecules take electrons from the anode and are reduced to oxygen ions by reduction. The oxygen ions react with hydrogen ions from the anode and thus produce water.

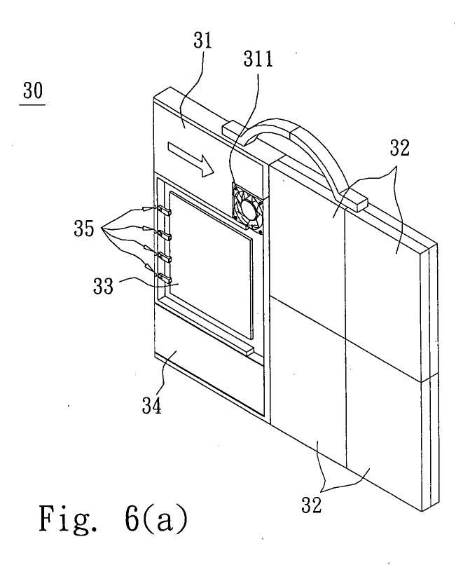

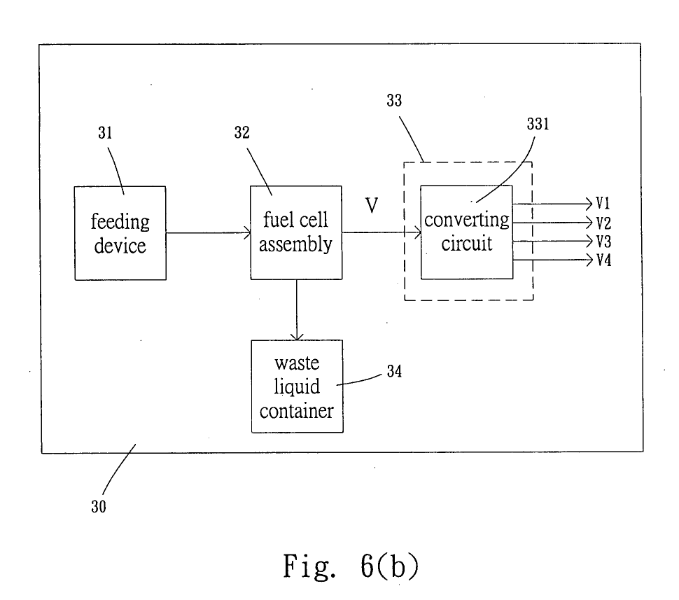

A further embodiment of a power supply apparatus is illustrated in FIGS. 6(a) and 6(b). In this embodiment, the arrangement of the feeding device 31, the planar fuel cell assembly 32, the circuit board 33 and the waste liquid container 34 included therein are similar to those shown in FIG. 3(a), and are not to be redundantly described herein. However, the power supply apparatus of this embodiment has a plurality of output terminals 35. Therefore, the DC input voltage V can be converted to a plurality of operating voltages (e.g. V1, V2, V3 and V4) required for more loads via the output terminals 35.

From the above description, the power supply apparatus of the present invention is capable of offering sufficient operating voltages for use with a plurality of electronic products even when the commercial AC power is not obtainable. The power supply apparatus is convenient to be carried because it is easily assembled and the weight, thickness and volume thereof are reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply apparatus for offering a voltage to be used with a load, said power supply apparatus comprising:
a fuel cell assembly performing an electrochemical reaction to generate an input voltage;
a feeding device having therein a fluid fuel and in fluid connection with said fuel cell assembly so as to introduce said fluid fuel into said fuel cell assembly;
a blower for introducing ambient air into said fuel cell assembly;
a detecting circuit electrically connected to said load, detecting an operating voltage of said load, and generating a triggering signal in response to the detecting result; and
a converting circuit electrically connected between said fuel cell assembly and said detecting circuit, converting said input voltage into said operating voltage in response to said triggering signal, and offering said operating voltage to said load.

2. The power supply apparatus according to claim 1 wherein said load is a portable electronic product.

3. The power supply apparatus according to claim 1 wherein said fluid fuel comprises methanol or hydrogen.

4. The power supply apparatus according to claim 1 wherein said feeding device is detachable from said power supply apparatus to supplement said fluid fuel.

5. The power supply apparatus according to claim 1 wherein said converting circuit is a charge pumping circuit.

6. The power supply apparatus according to claim 5 wherein said input voltage generated from said fuel cell assembly is a DC voltage, and said charge pumping circuit is a DC/DC converter.

7. The power supply apparatus according to claim 1 further comprising a waste liquid container for storing waste liquid generated from said electrochemical reaction and the unreacted fluid fuel.

8. The power supply apparatus according to claim 1 wherein said fuel cell assembly is a planar fuel cell assembly.

9. The power supply apparatus according to claim 1 wherein said detecting circuit and said converting circuit are mounted on a circuit board.

10. A power supply apparatus for offering a plurality of output voltages, said power supply apparatus comprising:
a fuel cell assembly performing an electrochemical reaction to generate an input voltage;
a feeding device having therein a fluid fuel and in fluid connection with said fuel cell assembly so as to introduce said fluid fuel into said fuel cell assembly;
a blower for introducing ambient air into said fuel cell assembly; and
a converting circuit electrically connected to said fuel cell assembly for converting said input voltage into said plurality of output voltages to be used with corresponding loads.

11. The power supply apparatus according to claim 10 wherein said loads are portable electronic products.

12. The power supply apparatus according to claim 10 wherein said fluid fuel comprises methanol or hydrogen.

13. The power supply apparatus according to claim 10 wherein said feeding device is detachable from said power supply apparatus to supplement said fluid fuel.

14. The power supply apparatus according to claim 10 wherein said converting circuit is a charge pumping circuit.

15. The power supply apparatus according to claim 14 wherein said input voltage generated from said fuel cell assembly is a DC voltage, and said charge pumping circuit is a DC/DC converter.

16. The power supply apparatus according to claim 10 further comprising a waste liquid container for storing waste liquid generated from said electrochemical reaction and the unreacted fluid fuel.

17. The power supply apparatus according to claim 10 wherein said fuel cell assembly is a planar fuel cell assembly.

18. The power supply apparatus according to claim 10 wherein said detecting circuit and said converting circuit are mounted on a circuit board.

19. A power supply apparatus for offering a plurality of output voltages, said power supply apparatus comprising:
a fuel cell assembly performing an electrochemical reaction to generate an input voltage;
a feeding device having therein a fluid fuel;
a waste liquid container for storing waste liquid generated from said electrochemical reaction and the unreacted fluid fuel;
a mixing container connected between said feeding device, said planar fuel cell assembly and said waste liquid container, mixing said fluid fuel from said feeding device and said waste liquid from said waste liquid container to introduce a mixture of said fluid fuel and said waste liquid into said fuel cell assembly;
a blower for introducing ambient air into said fuel cell assembly; and
a converting circuit electrically connected to said fuel cell assembly for converting said input voltage into said plurality of output voltages to be used with corresponding loads.

20. The power supply apparatus according to claim 19 further comprising a return pipe connected between said mixing container and said waste liquid container for recycling said waste liquid to said mixing container therethrough.
